(19) United States
(12) Patent Application Publication
(10) Pub. No.: US 2017/0118956 A1
(43) Pub. Date: May 4, 2017

(54) PROTECTIVE EQUINE LEGGINGS AND BODYSUIT

(71) Applicant: MARK ALLEN EVANKO, PERALTA, NM (US)

(72) Inventor: MARK ALLEN EVANKO, PERALTA, NM (US)

(73) Assignee: THE MARK EVANKO LIVING TRUST, PERALTA, NM (US)

(21) Appl. No.: 14/931,878

(22) Filed: Nov. 4, 2015

(51) Int. Cl. A01K 13/00

(52) U.S. Cl. CPC A01K 13/008; A01K 13/007; A01K 2227/10

(57) ABSTRACT

The invention comprises equine leggings, harness, and one-piece, stretch fabric, zippered bodysuit or—as a variant—lightweight, long-tassel fringe bodysuit with modified harness. Combined, the invention provides complete equine body protection from flying and biting insects. The leggings stretch from hoof to shoulder; the harness encircles the neck then extends down the horse's spine from wither to rump; suspender-type straps extend from the harness to secure the leggings, which feature elasticized gussets at top and bottom to aid fitting; the bodysuit, with a singular, contoured zippered fastening under the belly, stretches around and over first the head, along the horse's body and back, then over the tail in one fitting. The long-tassel fringe bodysuit variant attaches to a modified harness that omits the suspender straps and adds a loop to encircle the tail. The horse can be ridden under saddle while wearing bodysuit, harness, and leggings.

### CROSS-REFERENCE: RELATED APPLICATIONS

Provisional Patent Application 62/077,215: “Stretchable, Garter-Fastened Protective Equine Leggings,” November 2014.

### FEDERALLY SPONSORED RESEARCH OR DEVELOPMENT

Not Applicable.

### SEQUENCE, TABLE, COMPUTER PROGRAM LISTING

Not Applicable.

### COMPACT DISC APPENDIX

Not Applicable.

### BACKGROUND OF INVENTION

Flying and biting insects are an irritant for horses and can pose a potential health risk in terms of skin infections and spread of disease, such as equine encephalitis and West Nile virus; moreover, open wounds can become infected if not kept clean and covered.

A horse attempting to eliminate the presence of flying or biting insects can also cause potential stress injury to joints and ligaments through repeated stamping of the legs. Moreover, the presence of flies, mosquitoes and other flying insects—and the resulting stamping, jerking or jumping movements as the horse tries to eradicate the presence of the insects—cause an irritating distraction to the concentration of the horse when being ridden, affecting the ability for people to ride and train their horses productively and safely.

This invention, while primarily for the deterrent of flying insects and secondarily for protection, such as keeping a bandage or dressing in place or otherwise keeping a wound clean, is designed to protect both the upper and lower portions of the horse's legs as well as the horse's body and underbelly.

Leggings and body coverings for horses are well represented in prior art, and generally either: a) offer leg protection for the horse; or, b) act as a deterrent to flying insects and other pests.

The majority of inventions in prior art protect only the lower legs of the horse and do not offer protection for the entire leg. In contrast, this invention encases the entire leg in fabric; alternatively, the body and legs are encased by lightweight tassels that, due to the movement of a plurality of strings that extend down on either side of the horse to a length of up to 80 inches, are secured along the spine of the horse by way of attachment to a modified harness. Notably, the latter also permits the free flow of air, thereby offering a means of protection from flying and biting insects while still permitting significant air circulation.

While flysheets and other types of horse blankets or coverings are near-ubiquitous in lines of equine apparel—and most cannot, due to bulk and design, be worn under saddle—few approach the concept of “bodysuit,” which is a close-fitting, contouring garment designed to be worn alone or under saddle. Further, while prior art teaches the use of zipper fastenings underbelly for bodysuit-type equine apparel, the current invention is notable due to the speed and simplicity of “pull on/pull off” design, meaning that the bodysuit of the current invention can be fitted in under fifteen seconds and removed in less than ten seconds.

Such ease in fitting and removing the bodysuit garment has been partly achieved by the use of stretch fabric, which is also seen in prior art; however, the novel design of the current invention's bodysuit is marked by its head and tail circular openings that do not require additional fastenings or other types of securing once slipped on, or off, the horse. Additionally, the lightweight long-tassel fringe bodysuit variant, secured solely by a single stretch, pull-on/pull-off modified harness, is not indicated in prior art relating to protective or decorative equine apparel.

The current invention features three fastening methods: the first, for the leggings, comprises suspender/garter-type straps and “grip clips” attached to a singular backstrap that runs, lying flat, along the spine of the horse, meaning that the apparatus can be worn under saddle without impeding the horse's gait and movement or the ability of the rider to ride the horse; the second, for the bodysuit, eliminates use of hook, buckle, or Velcro® fastenings to instead stretch quickly and easily over both head and tail of the horse by means of an open hole at front and end of the bodysuit and is then secured by a contoured underbelly zipper; and the third, the long-tassel variant of the bodysuit, is secured solely to the harness backstrap without any other means of securing fasteners, then lays flat over either side of the horse's body to a length of up to five feet, but which can ultimately be determined by the horse's owner through trimming of the tassels.

There is a deliberate omission of more traditional fastenings, such as buckles, ties, and Velcro®, with the latter rejected due to its tendency to become matted and ineffective when horses are out in the fields. The use of stretch fabric assists in fitting the leggings and bodysuit and minimize fastenings; further, the use of a gusseted, elasticized insert at the top and the bottom of the leggings further enhances ease of dressing and security of fit without the need for additional fastening arrangements at the base of each legging.

Prior art that teaches the protection of horses from flying and biting insects and/or to offer therapeutic application include: U.S. Pat. No. 903,149 (1908) to Bowlds; U.S. Pat. No. 2,246,100 (1941) to Marzani; U.S. Pat. No. 4,305,243 (1981) to Yu; U.S. Pat. No. 4,342,185 (1982) to Pellew; U.S. Pat. No. 4,791,777 (1988) to Sacane; U.S. Pat. No. 5,137,508 (1992) to Engman; U.S. Pat. No. 5,361,564 (1994) to Hickman; U.S. Pat. No. 5,676,094 (1997) to Gun-Munro; U.S. Pat. No. 6,151,873 (2000) to Rogers; U.S. Pat. No. 6,499,438 (2002) to Torres; U.S. Pat. No. 6,508,205 (2003) to Zink; and U.S. Pat. No. 8,316,626 (2012) to Sherer.

In contrast to the current invention, much prior art teaches protective garments that cover the lower-half of the horse's or animal's leg rather than the full length of the leg (U.S. Pat. No. 2,246,100 to Marzani; U.S. Pat. No. 4,791,777 to Sacane; U.S. Pat. No. 5,361,564 to Hickman; U.S. Pat. No. 4,342,185 to Pellew; U.S. Pat. No. 4,305,243 to Yu; U.S. Pat. No. 5,137,508 to Engman; U.S. Pat. No. 5,676,094 to Gun-Munro; U.S. Pat. No. 6,151,873 to Rogers; and U.S. Pat. No. 6,508,205 to Zink), using fastening methods other than the current invention's adjustable suspender-type “grip clips,” with Velcro® (U.S. Pat. No. 5,137,508 to Engman; U.S. Pat. No. 5,361,564 to Hickman; U.S. Pat. No. 4,342,185 to Pellew; U.S. Pat. No. 6,499,438 to Torres; U.S. Pat. No. 5,676,094 to Gun-Munro; U.S. Pat. No. 8,316,626 to Sherer; and U.S. Pat. No. 6,508,205 to Zink) or a hook and loop system (U.S. Pat. No. 5,137,508 to Engman; U.S. Pat. No. 5,361,564 to Hickman; U.S. Pat. No. 5,676,094 to Gun-Munro; U.S. Pat. No. 6,151,873 to Rogers; and U.S. Pat. No. 6,508,205 to Zink) being the most often cited fasteners.

Buckles, buttons, and press-studs are also used as fastenings (U.S. Pat. No. 4,342,185 to Pellew; U.S. Pat. No. 903,149 to Bowlds; U.S. Pat. No. 6,499,438 to Torres; and U.S. Pat. No. 2,246,100 to Marzani), with one example of prior art (U.S. Pat. No. 8,316,626 to Sherer) teaching “rope, buttons, adhesive bonding materials, string, wire, clips, pins, elastic band materials, straps, and ties” as secondary fasteners to Velcro®.

Multiple prior art teaches the use of fastenings to close the leggings that attach in one or more vertical places of the leg of the animal (U.S. Pat. No. 2,246,100 to Marzani; U.S. Pat. No. 5,137,508 to Engman; U.S. Pat. No. 4,342,185 to Pellew; U.S. Pat. No. 8,316,626 to Sherer; U.S. Pat. No. 6,151,873 to Rogers; U.S. Pat. No. 6,499,438 to Torres; and U.S. Pat. No. 6,508,205 to Zink). This differs distinctly from the current invention that is instead characterized by a sewn tubular legging that does not require closure fastening up the vertical axis of the legging.

From two examples of prior art that teach full-length leg protection, neither features the characteristics of the current invention. Both U.S. Pat. No. 8,316,626 to Sherer and U.S. Pat. No. 6,499,438 to Torres differ significantly by way of vertical leg fastenings as opposed to a singularly-sewn tube, and though one features elasticized straps (U.S. Pat. No. 6,499,438 to Torres), neither has a full-length, horizontal back strap and neither demonstrate a recognizable means of preventing the legging slipping down over or under the animal's hoof when it ambulates—unlike the gusseted elasticized inserts of the present invention that fits around the base of the horse's pastern and stretches to accommodate the shoulder.

Prior art relating to an equine bodysuit—notably, U.S. Pat. No. 5,127,213 to Petronio—teaches a “blanket-type member” that “supports weights in either a fixed or variable relation . . . disposed on the back of an animal for training and conditioning purposes,” which is dissimilar in both design and purpose to the bodysuit concept of the current invention. Petronio, however, does teach the use of a “leotard-like undergarment fitting around the body of an animal,” yet this extends only from shoulder of horse to the hip and is fastened at front by way of “a suitable fastener, such as . . . fabric loop and hook” and “may include a strap or the like.” The patent acknowledges undercovers of the type described are “commercially available under the trade designation of W′UNDERCOVER[,] marketed by W′Undercover for Equines, a division of New Tech Enterprises, Inc., Chester Springs, Pa.”

The current invention, in contrast to both Petronio and the products commercially available through W′Undercover for Equines, differs by way of the unique slip-on/slip-off properties afforded by the two large stretch openings at front and rear of the bodysuit, and the contoured zippered fastening on the underbelly. Further, there is no comparative correlation between either the patent to Petronio or W′Undercover in relation to the current invention's lightweight long-tassel fringe variant of the bodysuit.

U.S. Pat. No. 6,574,948 B2 to Longtin similarly teaches apparel designed to fit around the body of an animal, yet rather than being a one-piece stretch equine garment, it comprises instead “[a]n ensemble of from one to three garment sections . . . to cover portions of the animal's body that are susceptible to harassment by biting or stinging insects.” The prior art here also features a system of Velcro® fastenings, including under the tail and under the girth or belly of the animal, as well as leg straps that wrap around each leg, which is distinctly different from the one-piece, “pull-on/pull-off” and contoured zippered fastening of the current invention's bodysuit garment.

U.S. Pat. No. 5,361,563 to Llamas describes as a “one-piece covering for a horse comprising a chest covering which covers the horse's shoulders and breast and at least partially covers the horse's withers” that “can also include a back covering which extends from the chest . . . and covers the horse's ribs, loins, haunches, and croup at least partially covers the horse's thighs.” The art, however, like that to Longtin, is in three pieces: a hood, a neck/mid-body, and back covering. The hood contains an “opening enlargement device” for “selectively enlarging the hood opening such that the horse's entire head can be received through the hood opening” and a “girth strap for securing the one-piece covering to the horse.” The body protection of the current invention differs significantly in practice: it is a one-piece, stretch-fabric bodysuit covering the horse from wither to rump that does not need “opening enlargement device[s],” nor girth straps, nor Velcro® fastenings.

U.S. Pat. No. 7,636,087 to Graham illustrates a “strapless horse blanket made of stretch material” and points out that “[t]he combination of several different means of attachment (i.e., adjustable straps and hook and loop fasteners) or complex attachment systems increases the difficulty and time required in taking the blanket on and off the horse.” Of note, however, is that all described iterations of prior art in this patent, including the preferred embodiment, involve five separate points of closure, all with hook and loop fastening, in contrast with the current invention that comprises just one: a close-to-the-body-fitting, underbelly zip configuration.

U.S. Pat. No. 2,215,037 to Hintgen (1940) describes a “fly net,” characterized by a blanket-type “body” fabric made from lightweight canvas or similar material and tied to the horse by way of pleats, strings, breast-strap, hooks, and loops, from which hangs a sequence of strings. While the current invention's variant bodysuit similarly teaches tasseled strings as a means of fly repellant, it differs distinctly from Hintgen in that it is suspended from a modified harness that, in its preferred configuration, eliminates all traditional closures and fastenings entirely as it is designed to be both secured and removed on a simple pull-on/pull-off basis. A singular harness with circular stretch-elastic martingale slips over the horse's head, then extends by way of a backstrap along the spine of the horse to the rump, and a circular, elasticized tail loop extends outwards to permit the horse's tail to be pulled through, thereby securing the harness in place. A sequence of tasseled strings, up to 80 inches in length (the final length which can be determined by the owner depending on the height of the horse), is sewn along the backstrap of the harness and hangs down either side of the horse's spine, rump, and neck to provide constant motion from wind or movement that, in turn, repels flying insects.

### REFERENCES

“Equitard Silver Turnout by W'Underwear” Hello Trade! Sep. 18, 2015.

### SUMMARY OF INVENTION

The design objective was to overcome any predictability in outcome, and one of the ways this was achieved emerged during trials and prototyping of the garment as described in the provisional patent application (62/077,215: “Stretchable, Garter-Fastened Protective Equine Leggings”; date of filing/issue or 371(c) date: November, 2014. That document described the invention as a “set of four seam-sewn leggings for horses . . . attached by way of suspender-type metal clip fasteners and adjustable garter-type suspender straps . . . sewn to [a] backstrap to aid stability . . . [with] material [that] allows for both good air circulation and the wicking of sweat.” The provisional application also included reference/claim to “[g]athered, soft-stretch elastic sewn into each of the leggings at the top of each hoof to create a rouched effect around the pastern.”

In the field, in the prototyping phases of testing both the invention's commercial interest and tangible application, it was quickly recognized that while flying and biting insects were deterred through use of the leggings, the rest of the body remained unprotected: as a consequence, the complementary bodysuit component—as part of a whole body protective device—was developed. Use of a variety of fastenings for animal or equine body coverings is taught extensively in prior art; however, a system of hook-and-loop, strap, button, clasp, or clip-type closures are time consuming to construct in the process of fitting the garments, and a potential hazard if the straps or clips become caught in objects when the horse is out in the field. The objective, therefore, was responding effectively to the identified need to create a bodysuit whereby—teaching away from prior art—the speed of fitting and simplicity of design would be foremost characteristics, and create a complementary subsidiary of the stated intention to protect from flying and biting insects.

During the prototyping phase of the bodysuit, it was also noted that, in extremely hot weather, these garments could inadvertently act as an insulator—even when the fabric wicked away sweat. Due to this observation, an unexpected and surprising design result emerged in the form of an identified need for a variant lightweight bodysuit that would effectively repel flying and biting insects, yet also permit extensive airflow and circulation around the horse's body and legs: the current invention's tasseled bodysuit was developed to achieve this stated need, which is unresolved in prior art.

The invention constitutes four equine leggings to cover the lower and upper portions of a horse's four legs, a harness, comprising both martingale and backstrap, to secure the leggings, and a stretch, zippered one-piece bodysuit or—as a variant—lightweight, long-tassel fringe bodysuit. Combined, these garments provide horses with comfort and protection of body and legs from flying and biting insects. The leggings extend from the horses' hooves up the lower limbs to the top of the legs; the harness' martingale circles the neck then extends down the back of the horse's spine from wither to crown of the rump; suspender-type elastic straps extend from the harness from the martingale to the front legs and from the rear of the backstrap to the back legs. Each strap ends with two short elastic “V”-straps, to which is secured a “grip clip” commonly seen in suspender attachments so as to secure the leggings at the top of each leg.

The leggings feature stretch gore gussets at top and bottom to aid in fitting and comfort; the bodysuit, with one contoured zippered opening under the belly and no other fastenings, is fitted first over the horse's head by way of a stretchable opening, extends back along the body of the horse, then is stretched over the tail by way of a second stretchable opening. The variant long-tassel fringe bodysuit attaches solely to a modified harness characterized by a martingale (either a fully encircled opening or, alternatively, with a parachute-clip closure at the front of the chest) and an extended backstrap that features a circular, elasticized loop encased in a fleece-material sleeve, through which the tail is pulled. The horse can be ridden under saddle while wearing both bodysuit and leggings. Flies, mosquitoes, and other insects are unable to penetrate the fabric, leading to comfort and protection from insect bites and a reduction in annoyances for the horse.

The invention relates to the following classes: 54/4, 54/76, 54/79.1, 54/79.2, 54/80.4, 54/82.2; 119/36, 119/850; B68B/7, B68C/5; A01K 13/007, A01K 13/008; D30/144, D30/145.

### DESCRIPTION OF DRAWING VIEWS

FIG. 1: Side view of horse showing placement of harness (martingale, backstrap, vertical elastic straps, grip clips) and leggings.

FIG. 2: Martingale parachute-clip encased in fleece-material sleeve.

FIG. 3: Legging with trapezoid design, top and bottom gored, stretch-elastic gussets, and rolled elastic cord at top of legging.

FIG. 4: Modified harness (martingale, extended backstrap, tail loop) and tasseled bodysuit.

FIG. 5: Stretch bodysuit (with contoured elastic underbelly flap).

### DESCRIPTION OF INVENTION

This invention is a system of protective legging and bodysuit/body coverings, particularly in relation to ease of fitting and removal due to the elimination of nearly all traditional fastenings with the bodysuit and tasseled variation. The stretch fabric, which is an appropriate thickness to prevent insect bites, is not only durable enough to withstand the proboscis of a flying insect, but light enough to avoid overheating. Indeed, the tasseled bodysuit variant enables free flow of air circulation while simultaneously repelling flying and biting insects. Due to the elasticized suspender-type straps for placement of the leggings, along with the gusset openings at both top and bottom of each legging, a custom and comfortable fit can be easily achieved for each horse.

The harness backstrap, which runs from the base of the horse's wither to the crown of the rump, is made from a material that is soft and pliable, such as, but not limited to, nylon webbing or leather to which the suspender-type straps are sewn with reinforced stitching at four points: in a line running vertically above the apex of each shoulder (front) and hip (rear), and again a vertical line running from the top of the hip to each side adjacent to the crown of the rump. A singular, curved front piece to the harness that encircles the neck—also known and described as a “martingale”—made from the same material as the backstrap with a parachute-clip fastening at the front of the chest covered by a fleece-material sleeve, or a circular stretch elastic loop with no fastening, extends from the points just above the two front shoulders around the chest of the horse, and is designed to be pulled over the horse's head whether by parachute-clip fastening or, in the preferred embodiment, a stretch elastic opening to enable pull-on/pull-off operation.

In a modified variation of the harness designed to be worn with the tasseled bodysuit, the vertical elasticized leg straps are eliminated. While the martingale design remains intact, the backstrap is elongated to reach beyond the rump towards the top of the tail, and from this extends a circular, elastic loop through which the tail of the horse is pulled in order to secure the harness in place. The tail loop is encased in a fleece-material sleeve to eliminate chafing and promote comfort. The modified harness features a sequence of stringed tassels sewn along the horizontal length of the spine strap; the tassels then hang down up to five feet on either side of the horse. The movement of the tassels, whether in relation to wind, breeze, or ambulation, repels flying and biting insects while maximizing opportunity for airflow and circulation.

The lightweight long-tassel fringe bodysuit variant, secured longitudinally along the backstrap of the harness, is made from stringed fabric including, but not limited to, polyester, nylon, polycotton, cotton, leather, feathers, fur, elastic, LED strips, or threaded beads.

The leggings are fitted by first pulling each over the horse's hooves, then stretching the leggings up to the top of the horse's shoulder. The leggings are then attached to the harness by way of elongated vertical elastic straps, each of which end in two “V”-shaped short elastic straps, from which hang two suspender-type “grip clips,” which are then fastened to the top of each legging. These clips provide strength and durability and—unlike fastenings such as hook and loop, button, zip, buckle, or Velcro®, with the stretch elastic of the “V”-straps, the horse can move flexibly and freely while wearing the leggings.

Each legging is sewn as a singular tube, designed to slip over and be pulled up the horse's leg, rather than a device that is fastened with various vertical or horizontal fastenings (such as hook and loop, button, zip, or Velcro®) around the horse's leg. The gusseted, elasticized inserts at the top and bottom of each legging provides additional ease in terms of dressing: each legging stretches around to fit over the hoof and is pulled up as one complete piece before fastening at the shoulder or hip. This design also means that replacement of each legging, should it become torn or soiled, is very simple.

The gusseted, elasticized inserts contract and expand sufficiently to fit securely around the horse's pastern and at the base of the shoulder; therefore, resisting falling down and off the leg. Material used for the leggings includes, but is not limited to, fabric such as stretch panne velour, stretch Jersey knit, stretch polycotton, Lycra® or Spandex.

The bodysuit is a one-piece design made from a fabric such as, but not limited to, stretch panne velour, stretch Jersey knit, stretch polycotton, Lycra® or Spandex. It comprises a garment with two open holes at either end: one stretch opening at the front of the garment that is pulled over the horse's head, and the other stretch opening at the rear of the garment that expands sufficiently to permit the horse's tail to be pulled through the opening. The bodysuit then stretches over each side of the horse and is secured by a contoured, stretch fabric, underbelly flap that is zippered closed.

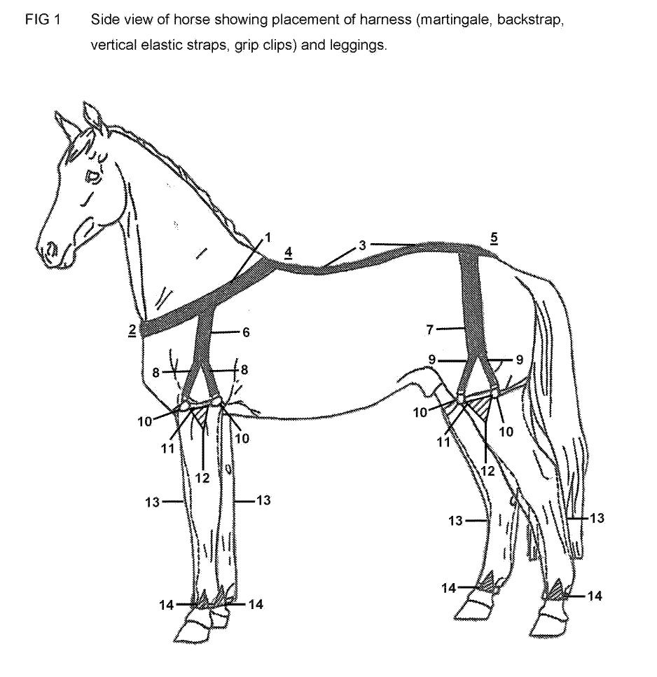

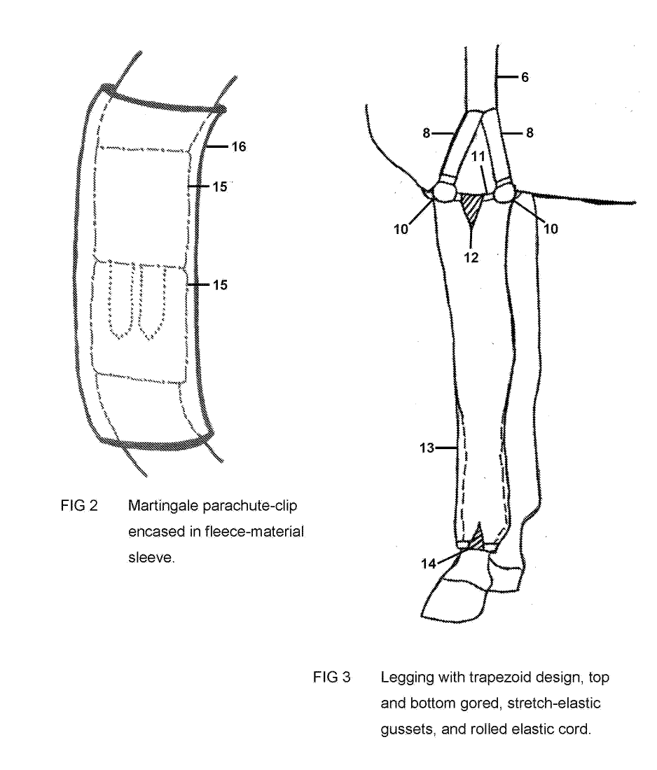

As shown in FIG. 1, the standard iteration of the invention's martingale (1)—a circular band or strap that encompasses the horse's chest from shoulder-to-shoulder—is fitted over the head of the horse in order to position it correctly around the horse's chest (2). The martingale may be a fully elasticized loop in the preferred embodiment or, as an alternative—and as indicated in FIG. 2—the martingale may be fastened at the center of the horse's chest at the base of the neck by a parachute clip (15), which is then encased in a fleece-material sleeve to offer protection and comfort (16).

The backstrap (3) in FIG. 1 is then positioned horizontally along the horse's spine from the base of the wither (4) to the crown of the rump (5). On each side of the horse, two nylon vertical straps (6, 7), with two elasticized “V” sections per vertical strap (8, 9) spreading out from the bottom of each strap, hang from the martingale (1) towards the front legs and from the backstrap (3) towards the back legs vertically against the horse's body.

At the end of each “V” section (8, 9) is sewn a metallic device, referred to in this invention as a “grip clip” (10) that is commonly used as a fastening for suspender belts and other belt-type attachments (see also FIG. 3). Further enhancing the gripping capability of each clip is that the top of each legging is reinforced with a strip of rolled cord (11) sewn into the seam, as in FIG. 1 and FIG. 3, onto and around which the “grip clips” are secured.

As in FIG. 1, once the standard backstrap (3) is in place, the leggings are pulled over the horse's hooves and stretched upwards to the top of each leg of the horse (13). The leggings are then secured to the harness on each of the four legs by way of the harness' vertical nylon straps from which two elasticized “V” section straps per leg spread outwards (8, 9). At the end of each “V” section, as previously described, is sewn a metallic device, known in this invention as a “grip clip” (10). Further enhancing the gripping capability of each clip is that the top of each legging is reinforced with a strip of rolled cord (11) sewn into the seam, as in FIG. 3, onto and around which the clips are secured.

Each legging, two at the horse's front and two at the back (FIG. 1; 13), features a trapezoid design comprising a “V”-shaped gore—an elasticized, expandable gusset at both the top (12) and bottom (14) of each legging that permits an appropriate stretch and fit around the top of the horse's shoulder as well as sufficient stretch and opening to allow the legging to slip over the horse's hoof when putting on the legging (see also FIG. 3; 12, 14). The fabric of each legging is designed for maximum stretch and includes, but is not limited to, stretch panne velour, stretch Jersey knit, stretch polycotton, Lycra® or Spandex—so that the leggings will accommodate the fitting requirements of different horses without the need to be custom-made for each horse. The leggings are first placed onto each leg by rolling them up into a compressed circle that stretches out to fit over the horse's hoof, then pulled up to extend the legging over the full length of the horse's leg. The leggings are then attached to the straps with the suspender-type “grip clip” (FIG. 3; 10), which is, in turn, securely clasped around the rolled cord (11) sewn into the top of the legging.

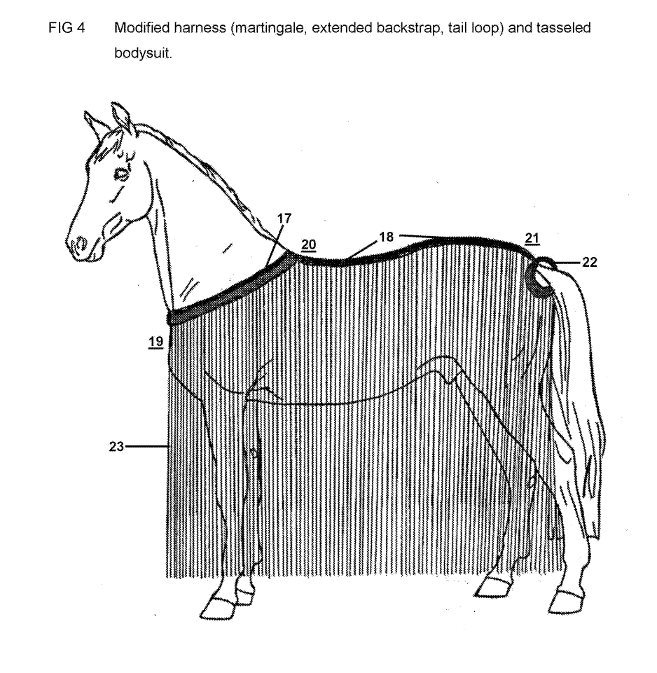

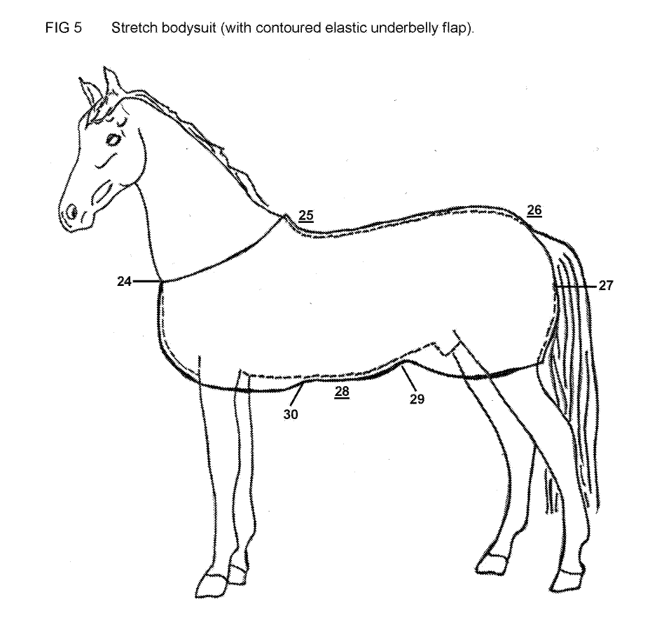

The modified embodiment of the invention's harness backstrap involves first gathering the tassels in the hand to facilitate ease of fitting. As in FIG. 4, once the tassels are secured in this way, the harness' martingale, a fully elasticized loop (17), and backstrap (18) are pulled over the head of the horse in order to position the martingale correctly around the horse's chest (19) and to lay flat at the base of the horse's wither (20). The backstrap is then laid out along the horse's spine to extend slightly past the crown of the rump (21). A second fully elasticized loop (22) is then extended outwards towards the rear of the horse and the tail is gently pulled through it. The loop is covered in a fleece-material sleeve to eliminate chafing and increase comfort. The tail is then laid flat against the horse's rear, thereby securing the modified harness in place. The tassels of the modified backstrap are then released and left to hang down in a vertical fashion on either side of the horse (23). The tassels may be trimmed or cut to the length desired by the horse's owner.

As shown in FIG. 5, the stretch bodysuit is designed to be fitted easily and quickly with a pull-on/pull-off approach. The bodysuit is first pulled over the head of the horse by way of an elasticized circular opening (24) to accommodate the head and neck. The bodysuit is then positioned to sit at the base of the horse's wither (25), and then stretched out along the horse's spine to sit just beyond the crown of the rump (26). A second elasticized circular opening (27) is extended down beyond the horse's tail; the tail is then pulled through the opening. The bodysuit is stretched down on either side of the horse's body, and then the contoured, stretch fabric, underbelly flap (28) is brought together under the horse's belly. The flap is then secured by the zipper that extends from a point just forward of the horse's rear legs (29) to a point just prior to the horse's front legs (30).

The material figurations of the invention as described here is intended as exemplary and illustrative in nature. Modifications and variations on the stated fabrics and specified design elements to achieve an equivalent product are not only readily envisioned, but also probable given changes and advances in both fabric production and the elements of this invention's design All such modifications and variants are acknowledged and fully intended to be within the scope of the claims made in this invention.

I claim:

1. Stretchable, garter-fastened protective leggings and bodysuit as part of a whole-body approach to equine comfort and protection from flying and biting insects, comprising:
a) a harness, constituting a circular neck strap (known as a “martingale”) and a backstrap that extends horizontally along the spine of the horse from wither to rump, with two vertical nylon straps per side of horse, two elasticized “V” sections per vertical strap, and fasteners suspended from martingale and backstrap to secure the leggings;
b) leggings extending from each of the horse's four hooves to the shoulder (front) and hip (rear), then secured to the harness;
c) a one-piece, stretch bodysuit covering secured with one zippered, contoured underbelly fastening to cover the horse from afore the shoulder to the rump, then surrounding the tail; and
d) a lightweight, long-tassel fringe variant bodysuit attached longitudinally along the backstrap of a modified harness that omits vertical leg straps and extends along the spine to an encircled elastic loop around the horse's tail.

2. Apparel as described by claim 1(a), wherein:
the martingale, a circular loop of nylon strapping, is secured by a parachute clip, or 2″ elastic that stretches to fit around the horse's neck, and—in the preferred embodiment—is a closed, stretch loop, but may also include a parachute-type clip fastening that is encased in a fleece-material sleeve to eliminate chafing and promote comfort.

3. Apparel as described by claim 1(a), wherein:
the backstrap of the harness comprises nylon, leather, or similar-type strapping and elastic straps, with fasteners including, but not limited to, suspender “grip clips” or other such fastening arrangements.

4. Apparel as described by claim 1(b), wherein:
the leggings are pulled onto and up the horse's legs without vertical fastenings; as such, they feature a stretch, gored gusset at top and bottom to aid in fitting.

5. Apparel as described by claim 1(b), wherein:
the leggings are made from fabric including, but not limited to, stretch panne velour, stretch Jersey knit, stretch polycotton, Lycra® or Spandex.

6. Apparel as described by claim 1(c), wherein:
the stretch bodysuit is made from fabric including, but not limited to, stretch panne velour, stretch Jersey knit, stretch polycotton, Lycra® or Spandex and includes a contoured stretch fabric underbelly flap and zippered closure.

7. Apparel as described by claim 1(d), wherein:
the long-tassel fringe bodysuit is secured longitudinally along the backstrap of a modified and extended harness, comprising a plurality of close-fitting, string-type tassels up to 80 inches in length, made from fabric or material including, but not limited to, polyester, nylon, polycotton, polycarbonate, cotton, leather, fur, elastic, threaded beads, LED strips, or other natural or synthetic string-like material.

8. Apparel as described by claim 1(d), wherein:
the modified harness omits vertical leg straps and instead encircles, in elastic, the horse's tail, with the tail loop encased in a fleece-material sleeve.
